(19) United States
(12) Patent Application Publication
(10) Pub. No.: US 2005/0259588 A1
(43) Pub. Date: Nov. 24, 2005

(54) Method and apparatus for predicting a link interruption in an ad hoc communications network using a manet type routing protocol

(75) Inventor: Christophe Preguica, Massy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/126,216

(22) Filed: May 11, 2005

(30) Foreign Application Priority Data
May 18, 2004 (FR) 04 50 980

(51) Int. Cl. H04L 12/26; H04L 12/28

(52) U.S. Cl. 370/248; 370/254; 370/389

(57) ABSTRACT

An ad hoc communications network with MANET type routing protocol is arranged to implement a method dedicated to predicting the interruption of a link between routers (R1, R2) of an ad hoc communications network with a MANET type routing protocol. The method consists, in each router (R1, R2) of the network, in measuring the intensity levels of signals coming from at least of the neighboring routers thereof, and in comparing each measured intensity with a selected threshold. Thus, when a router (R1) detects that the measured intensities of signals coming from a link with a neighboring router (R2) is below the threshold, it considers that the link has been interrupted and it sends a message to at least one of its neighboring routers for the purpose of mitigating the consequences of this link being interrupted.

The invention relates to the field of ad hoc communications networks of the type that use a MANET type routing protocol (for “mobile ad hoc network”).

As known to the person skilled in the art, routing within an hoc network is intended to enable data to be conveyed optimally from at least one source router to one or more destination routers (or receivers). The routing may be of the proactive or reactive type.

Routing is said to be “reactive” when each router needs to request each routing path because it does not know the topology of the network. Routing is said to be “proactive” when each router can calculate each routing path because of its own knowledge of the topology of the network.

Such ad hoc communications networks can be of the point-to-point (or “unicast”) type or they may be of the point-to-multipoint (or “multicast”) type.

A multicast proactive routing protocol can rely on mesh-based routing or on tree-based routing. Mesh-based multicast routing consists in defining a plurality of paths between each source router of a network and the receiver routers, while tree-based multicast routing consists in defining a single optimum routing path between a source router and the receiver routers, defining a hierarchical tree structure.

When a link between two neighboring routers in a hierarchical tree structure is interrupted, for example because one of the routers has been moved, the tree structure needs to be renegotiated at network level. Since the time needed to reconstruct a tree structure can be relatively long, data packets can be lost. Consequently, this type of protocol is not well adapted to network equipment being mobile.

Unicast proactive protocols have been designed to enable each router to send routing information to each of the neighboring routers, informing all of them about the neighboring routers to which it is linked. The TBRPF protocol is one such protocol and is described, for example, in U.S. patent application No. 2002/0012320.

In proactive protocols, each router can determine the optimum path for transferring data to a destination router. When a link is interrupted between two neighboring routers, the routers neighboring those two routers must wait until they have received updated routing information from them so as to be able to take account of the interrupted link when calculating routing paths. Consequently, so long as the routers have not received such updates, certain calculated paths will not be good.

Since no proactive or reactive routing protocol is fully satisfactory in ad hoc networks, the invention seeks to improve the situation.

To this end, the invention provides a method dedicated to predicting link interruptions between routers of an ad hoc communications network using a MANET type routing protocol, and consisting in measuring within each router of the network the intensity of the signals reaching it from at least one of its neighboring routers, and then in comparing each measured intensity with a selected threshold. Thus, when a router detects that the measured intensity of signals coming from a link with a neighboring router is below the threshold, it assumes that the link has been interrupted and transmits to at least one of its neighboring routers a message for the purpose of mitigating the consequences of the link being interrupted.

Two circumstances can be envisaged depending on whether the routing protocol is of the multicast type or of the unicast type.

In the presence of a multicast routing protocol, and of a hierarchical tree structure of the parent/child type established between a source router and at least one receiver router, via so-called “intermediate” routers, the intensity of signals coming from the “parent” router is measured at each router in the tree structure, and said measured intensity is compared with a selected threshold. Thus, when a “child” router detects that the measured intensity of signals coming from the link with that router's parent router is below the threshold, it sends a message in point-to-point mode to a neighboring router in the network, other than its parent router, said message comprising a request to join the tree structure and specifying the source router.

Two situations can then arise:
a) if the neighboring parent router is already associated with another child router in the tree structure, then it is associated with the requesting child router so as to cause it to join the tree structure, and the value of state information representative of the number of child routers associated with the parent router is incremented by unity; and
b) if the neighboring parent router is not already associated with another child router of the tree structure, it is associated with the requesting child router and its state information is given the value “one”, and then it is caused to transmit a message in point-to-point mode to another neighboring router in the network which then constitutes its own parent, which message comprises a request to join the tree structure and designates said source router; and then
c) operation a) or operation b) is reiterated with the neighboring parent router that receives the join request depending on whether it is or is not itself already associated with another child router of the tree structure.

The join request preferably includes a “unicast” address specifying the source router and a “multicast” group address.

In the presence of a unicast routing protocol, in each router of the network, the intensity of signals coming from each of the neighboring routers is measured, and then each measured intensity is compared with a selected threshold. Thus, when a router detects that the measured intensity of signals coming from a link with one of its neighboring routers is below the threshold, it sends to each of its neighboring routers a message including information representative of that link being interrupted, and preferably designating the router which can no longer be reached because of this link interruption.

In both of those two situations, it is advantageous in each router to measure the time that has elapsed from the beginning of a link interruption, so as to transmit a message only on condition that a selected first duration has elapsed (with the measured intensity continuing to remain below the threshold throughout said duration).

The invention also provides apparatus dedicated to predicting a link interruption between routers for routing in an ad hoc communications network using a MANET type routing protocol. The apparatus is characterized by the fact that it comprises processor means for acting in the router containing said processor means, to compare a selected threshold with the measured intensity of signals coming from at least one of the neighboring routers. Thus, when the processor means detect a measured intensity below the threshold on a link with a neighboring router, they consider that the link is interrupted and instruct a message to be sent to at least one of the neighboring routers for the purpose of mitigating the consequences of the link being interrupted.

The apparatus may be implemented in various ways depending on whether the routing protocol is of the multicast type or of the unicast type.

In the presence of a multicast routing protocol and a hierarchical tree structure of the “parent/child” type established between a source router and at least one receiver router of the network having the router containing the apparatus joined therein, the processor means serve to compare the selected threshold with the measured intensity of the signals coming from the router in the tree structure that is the parent of the associated router. Thus, when the processor means detect a measured intensity below the threshold on the link with the parent router, they order the message to be sent in unicast mode to a neighboring router of the network other than the parent router, said message including a request to join the tree structure and specifying the source router.

This join request preferably includes a unicast address specifying the source router and a multicast group address.

In the presence of a unicast routing protocol, the processor means serve to compare the selected threshold with the measured intensities of signals coming from each of the routers neighboring the router in which said means are located. Thus, when the processor means detect that a measured intensity is below the threshold over the link with any one of the neighboring routers, they order a message to be sent to each of the neighboring routers, which message contains information representative of the link interruption, and preferably designating the router that can no longer be reached because of the link interruption.

Furthermore, the apparatus may also comprise counter means serving, in the event of a measured intensity being found to be below the threshold, to trigger a timeout count and to deliver a timeout signal when the time that has elapsed since the beginning of such detection is equal to a selected timeout duration (providing the measured intensity continues to remain below the threshold throughout said duration). Under such circumstances, the processor means are arranged to transmit their message only on receiving the timeout signal.

Other characteristics and advantages of the invention appear on examining the following detailed description and the accompanying drawings, in which:

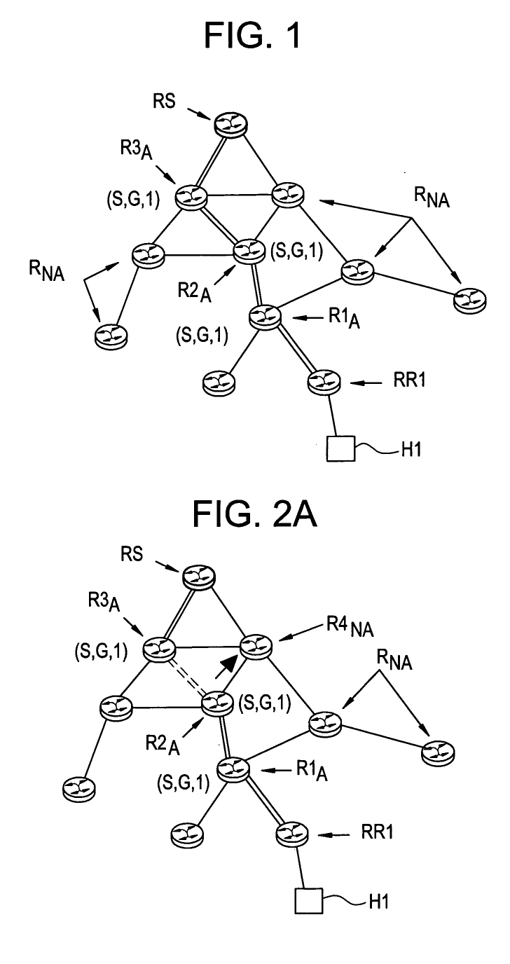

FIG. 1 is a diagram showing an example of a group of routers in an ad hoc network with a multicast proactive routing protocol of the MANET type, within which a hierarchical tree structure has been established between a receiver router and a source router;

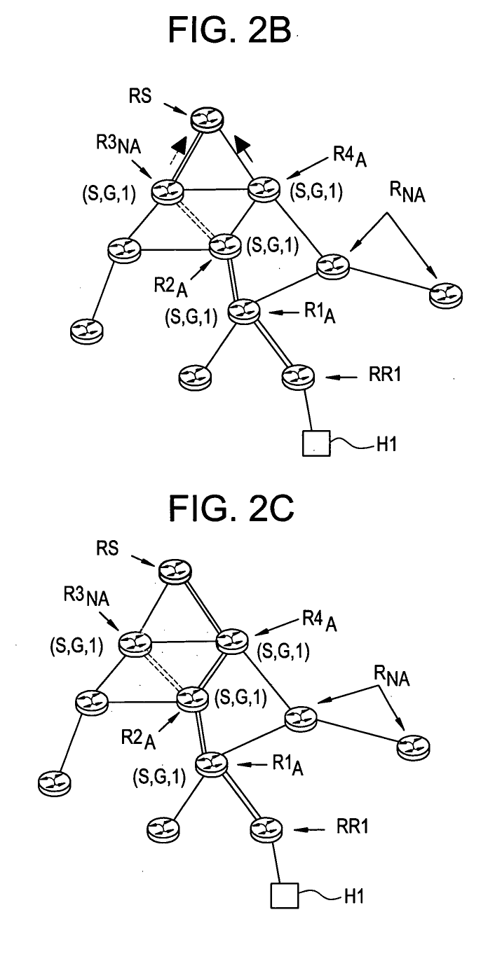

FIGS. 2A to 2C are diagrams showing the three successive stages enabling a link interruption to be predicted within the hierarchical tree structure example of FIG. 1, followed by a hierarchical tree structure being established that is new, in part;

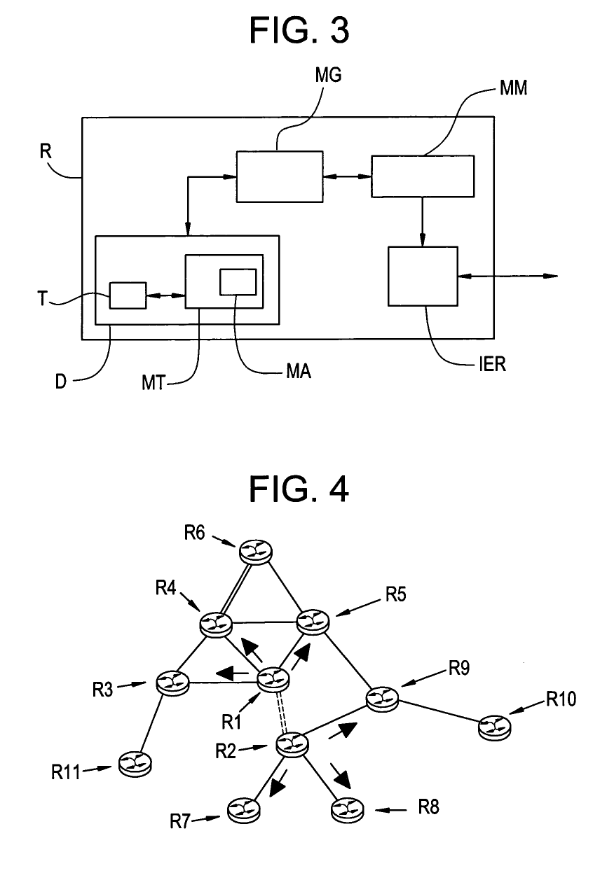

FIG. 3 is a diagram of an embodiment of prediction apparatus enabling the prediction method of the invention to be implemented in a router, in particular in an ad hoc network having a multicast proactive routing protocol of the MANET type; and

FIG. 4 is a diagram showing the operation of predicting a link interruption within a set of routers in an ad hoc network having a unicast proactive routing protocol of the MANET type, and also the signaling operations that stem therefrom.

The accompanying drawings serve not only to add to the description of the invention, but they can also contribute to defining it, where appropriate.

The invention seeks to enable a link interruption between routers to be predicted and to trigger appropriate actions in responses thereto within an ad hoc communications network having a MANET type routing protocol that may be proactive or reactive, multicast or unicast.

In a manner that is greatly simplified, but sufficient for understanding the invention, an ad hoc network can be thought of as a set or one or more groups of routers that may be fixed or mobile.

At its most general, in each router of an ad hoc network, the invention seeks to measure the intensity of signals coming from at least one of the neighboring routers, and to compare each measured intensity with a selected threshold. Thus, when a router in the network detects that the measured intensity of signals coming from a link with one of the neighboring routers is below the selected threshold, it assumes that the link has been interrupted and it sends to at least one neighboring router a message for the purpose of mitigating the consequences of this link being interrupted.

The term “mitigating the consequences of this link being interrupted” is used herein to mean triggering action that is appropriate in the light of the predicted link interruption. As described below, this action can vary depending on whether the routing is of the multicast type or of the unicast type.

Reference is made initially to FIGS. 1 to 3 while describing a first application of the invention to ad hoc communications networks having a multicast proactive routing protocol of the MANET type.

In this first application, by way of illustrative example, it is assumed that the ad hoc network uses a multicast proactive routing protocol such as the topology-broadcast based on reverse-path forwarding (TBRPF) protocol or the optimized link state routing (OLSR) protocol. However, the invention is not limited to these particular examples of multicast proactive routing protocols. It also applies to reactive routing protocols.

As shown diagrammatically in FIG. 1, a multicast ad hoc network may be considered as comprising at least one group G of routers comprising a source router RS and routers RR1, R_{A}, and R_{NA} that are not linked together in pairs in a “parent/child” type hierarchy so long as a hierarchical tree structure has not been organized. Potential links between routers that do not belong to a hierarchical tree structure are shown in the figures as single black lines.

Reference RR1 designates a router referred to as the receiver router which is momentarily connected to host type network equipment 8, e.g. belonging to a client who is a subscriber of the ad hoc network.

In order to enable a host 8 to exchange data with the source router RS of the group G to which it belongs, an optimum routing path needs to be defined between said source router RS and the receiver router RR1 to which it is connected.

In a network having a multicast proactive routing protocol, each router knows the topology of the network, so it is capable of determining the shortest (or optimum) routing path for conveying data to the source router RS. Consequently, each router is capable of determining which neighboring router lies above it in the hierarchy and to which it needs to forward the data it has received so that the data can be conveyed to the source router RS. The router constituting the less highly placed router of the two in the hierarchy is referred to as the child router, whereas the neighboring router is referred to as the parent router (neighbor).

An optimum path between a receiver router RR1 and a source router RS follows a hierarchical tree structure. An example of a hierarchical tree structure is shown in FIG. 1. More precisely, in this example, the hierarchical tree structure starts from the receiver router RR1, passes via a first “intermediate” router R1_{A}, then via a second intermediate router R2_{A}, and a third intermediate router R3_{A}, and terminates at the source router RS.

The references R_{NA} designate routers that do not form part of the hierarchical tree structure, whereas references Ri_{A} (in this case i=1 to 3) designate routers that form part of the hierarchical tree structure.

In FIG. 1, links established between two routers of the hierarchical tree structure are drawn as a pair of lines.

In certain situations, for example when one of the routers in the hierarchical tree structure moves, the signals it sends over a link of the hierarchical tree structure reach the neighboring router that is situated at the other end of the link with an intensity at a level that is continuously decreasing. Once the intensity of the signals received by one of the two routers concerned becomes less than a first threshold S1, the link is interrupted. In a conventional network, it is then necessary to renegotiate the complete hierarchical tree structure.

In order to avoid such a situation arising, each router of the ad hoc network is fitted with a predictor apparatus D of the type shown in FIG. 3.

Such a predictor apparatus D comprises a processor module MT for comparing a second selected threshold S2 (greater than the first threshold S1) with the measured intensity of signals coming from the router in the hierarchical tree structure that constitutes the parent of the router in which the apparatus is installed, e.g. R3_{A} is the parent of R2_{A}.

The intensity measurements may be provided by an intensity measurement module MM of the router R that is independent of the apparatus D and that is coupled to its transmit/receive interface IER, as shown in FIG. 3. Under such circumstances, the intensity measurements may be sent to the apparatus D by the management module MG of the router R, for example. However, in a variant, the apparatus D may have its own intensity measurement module coupled to the transmit/receive interface IER of the router R and its own processor module MT.

When the processor module MT detects intensity below the second threshold S2 and above the first threshold S1 over the link with the parent router R3_{A}, it considers that the link is interrupted and causes a message to be sent in unicast mode to a neighboring router in the network other than the parent router R3_{A}, e.g. R4_{NA} (as shown in FIG. 2A). In FIG. 2A, this transmission is represented by a bold arrow.

It is advantageous for the predictor apparatus D also to include a counter module T coupled to its processor module MT and serving, each time the processor module detects a measured intensity below the second threshold S2 and above the first threshold S1, to start counting a timeout. This module T may be a timer and it delivers a timeout signal to the processor module MT whenever the time that has elapsed since the beginning of detection reaches a selected timeout duration, for example 500 milliseconds (ms).

The processor module MT is then authorized to send its message to the new parent router, containing the request to join the tree structure, only in the event that it has also received a timeout signal from the counter module T.

Naturally, if the processor module MT, on making its comparisons (which are not interrupted), observes that the intensity of the signal over the link that is becoming interrupted moves back above the second threshold S2, then that causes the current time count to be interrupted in the counter module T. The timeout returns to the value zero (0). It is also possible to envisage that the timeout does not return to the value 0 and that counting is not stopped until the signal has remained above the second threshold S2 for a duration greater than a second duration T2 that is defined by another timeout. This makes it possible to be less sensitive to the radio environment and the numerous reflections therein.

The new parent router R4_{NA} is selected from the routers in the group G by the routing protocol in the child router R2_{A}, taking account of the interrupted link to the previous parent router R3_{A}. This routing protocol may be installed, for example, in the management module MG of the router R. It is important to observe that the apparatus D may constitute an additional portion of the routing protocol. Consequently, it may be implanted in the management module MG of the router R, or in a routing module coupled to the management module MG.

The message transmitted by the child router R2_{A} to the new parent router R4_{NA} includes (or constitutes) a request to join the tree structure and it specifies the source router RS.

This request to join preferably includes the unicast address specifying the source router RS and the multicast address of the group G.

In addition, each request to join that is received can be processed by an auxiliary module MA, e.g. implanted in the processor module MT of the predictor apparatus D, as shown in FIG. 3. However, in a variant, it could also be provided by an auxiliary module MA of the predictor apparatus D that is independent of its processor module MT.

The purpose of sending this request to join is to initiate reconstruction of a new top portion of the hierarchical tree structure, since the previous portion is no longer valid because a link has been interrupted, in this case the link between the routers R2_{A} and R3_{A}.

When the new parent router R4_{NA} receives the request to join transmitted by the child router R2_{A}, two circumstances can arise.

If the parent router is already associated with another child router in the group G, that means that a tree structure is already in existence and it forms a part thereof (it is then written R_{A}). For example, each router R_{A} belonging to a tree structure of the group G is associated with a state defined by a triplet comprising the unicast address S designating the source router RS, the multicast address G of the group, and state information of a value that represents the number of child routers associated therewith. In this first circumstance, the parent router (R4_{NA}) is associated with the requesting child router (R2_{A}) in order to cause it to join the preexisting tree structure, and the value of the state information in its triplet is incremented by unity.

In contrast, if the new parent router (R4_{NA}) is not already associated with a child router of the group G, no state is associated therewith. This situation is shown in FIG. 2A. In this second circumstance, the new parent router R4_{NA} is associated with the requesting child router R2_{A}, which is represented in FIG. 2B by a pair of lines, and its triplet is set up with the unicast address S designating the source router RS and the group multicast G contained in the request to join that it has received, together with a state information value that is equal to one (1).

The parent router now has a state and is therefore considered as forming part of the tree structure that is being built up, so it is referenced R4_{A}.

It is then caused to send a unicast message to its neighboring parent router, in this case the source router RS, constituting a request to join specifying said source router RS so as to continue building up the hierarchical tree structure towards the source router RS. This transmission is represented in FIG. 2B by a bold arrow.

When the source router RS receives from the router R4_{A} the request to join that specifies the source router, they are associated with each other as represented in FIG. 2C by a pair of lines. Since the neighboring parent router in this case is the source router RS, the top portion of the tree structure has thus been reconstituted such that a hierarchical tree structure has been established that is new in part.

Since the router R3_{A} is no longer associated with a child router, and since it is associated with the source router RS by a link forming part of the old top portion what is now unused, it is preferable to eliminate this old top portion from the reconstructed top structure. Naturally, this removal of a link does not take place so long as the parent router is still associated with at least one child router in spite of the link interruption. However, whenever a router no longer possesses any child routers, it should be withdrawn from the reconstructed tree structure by sending a withdrawal request to its parent router.

Thus, in the example shown, the router R3_{A} sends a request to withdraw from the tree structure (referred to as a “prune” request) to the source router RS (its parent). This transmission is represented in FIG. 2B by a dashed line arrow.

Nevertheless, it is advantageous for the parent router whose link with its only child router has been interrupted to wait for a few instants prior to transmitting to its own parent router its prune request to withdraw from the tree structure. The interruption of the link may be momentary only, for example as a result of a small movement of the parent or child router.

Under such circumstances, the parent router can start a timer programmed with a selected duration, e.g. equal to 500 ms, whenever it detects an interruption of the link with its child. Once the time lapse is equal to the selected timeout duration, the parent router then sends its own prune request.

The predictor apparatus D of the invention can be implemented in the form of electronic circuits, software (or computer) modules, or a combination of circuits and software.

Reference is now made to FIG. 4 while describing a second application of the invention to an ad hoc communications network having a unicast proactive routing protocol of the MANET type.

In this second application, it is assumed by way of illustrative example that the ad hoc network uses a unicast proactive routing protocol such as OLSR or TBRPF. However the invention is not limited to these particular examples of unicast proactive routing protocols. It also applies to unicast reactive routing protocols such as the “ad hoc on-demand distance vector” (AODV) protocol or the “dynamic source routing” (DSR) protocol.

Unlike a multicast protocol network as described above, a unicast protocol network does not have a tree structure. In the context of proactive protocols, ad hoc network routers exchange messages with neighbors, said message including routing information indicating in particular the neighbors with which they are “linked”, i.e. with which they can exchange data.

For this type of unicast protocol network, the invention proposes measuring within each of its routers the intensities of signals coming from each of the neighboring routers with which it is linked, and then comparing each measured intensity with the second threshold S2 (and also with the first threshold S1).

Thus, when one of the routers detects that the measured intensity of the signals coming over a link with one of its neighboring routers is less than the second threshold S2 and greater than the first threshold S1, it considers that the link is interrupted and sends to each of its neighboring routers a message including information representative of a link interruption.

The transmitted message may be a standard message containing routing information. However, it may also be in the form of a dedicated message specifying only the router that can no longer be reached because of a link interruption.

By means of this message, each neighboring router can update its own routing information before the link is in fact interrupted, and consequently can use its own routing protocol to calculate optimized paths that take account of said link being interrupted.

It is important to observe that the two routers that are linked together by a link that is about to become interrupted may possibly each detect at its own end that the intensity of the signals exchanged over said link is less than the second threshold S2 and greater than the first threshold S1. Thus, both routers will send to each of their respective neighbors messages indicating that the link is becoming interrupted, thereby accelerating propagation of information within the network.

This situation is shown diagrammatically in the example of FIG. 4. In this case, each of the routers R1 and R2 has detected that the measured intensity of signals being exchanged over their link is less than the second threshold S2. Each of them has thus decided to send to each of its own neighboring routers (that are accessible) a message stating that the link in question is interrupted. More precisely, the router R1 sends messages to its neighboring routers R3, R4, and R5, while the router R2 sends messages to its neighboring routers R7, R8, and R9. The transmission of these messages is represented in FIG. 4 by bold arrows.

As with a multicast protocol network, it is advantageous in this case also to implement a timer mechanism in order to ensure that the routers transmit their message(s) to neighboring routers only once the time that has elapsed since the beginning of detection is equal to a selected timeout duration.

This predictor method can be implemented within each router R of the ad hoc network having a unicast routing protocol by means of a predictor apparatus D of the type described above with reference to FIG. 3, with the exception of its auxiliary module MA, and while implementing those adaptations that are required because a routing protocol of a different type is being used, which comes within the competence of the person skilled in the art.

The invention is not limited to the implementations of the prediction method, or to the embodiments of the predictor apparatus or of the router as described above purely by way of example, but it covers all variants that the person skilled in the art might envisage within the ambit of the following claims.

1. A method of predicting a link interruption between routers (RR, R) in an ad hoc communications network having a MANET type routing protocol, the method being characterized in that in the presence of a “multicast” type routing protocol and of a “parent/child” type hierarchical tree structure set up between a “source” router (RS) and at least one “receiver” router (RR) via “intermediate” routers (R_{A}), each router in said tree structure measures the intensity of signals coming from its “parent” router and compares said measured intensity with a selected threshold, such that in the event of a “child” router detecting that the measured intensity level is less than said threshold over the link with its neighboring parent router, said child router transmits a message in point-to-point mode to a neighboring router in said network other than its parent router, and in that said message includes a request to join said tree structure and specifying said source router (RS).

2. A method according to claim 1, characterized in that:
a) if said neighboring parent router is already associated with another child router of said tree structure, said requesting child router is associated with said neighboring parent router so as to cause it to join said tree structure, and in said neighboring parent router, the value of state information representative of the number of child routers associated therewith is incremented by unity; and
b) if said neighboring parent router is not already associated with another child router of said tree structure, said requesting child router is associated with said neighboring parent router and the value “one” is given to said state information of said neighboring parent router, and said neighboring parent router is caused to transmit a message in point-to-point mode to another neighboring router of said network which will in turn constitute a parent router for said neighboring router, the message comprising a request to join the tree structure and designating said source router (RS); and then
c) operation a) or operation b) is reiterated with said neighboring parent router receiving a request to join depending on whether or not it is itself already associated with another child router of said tree structure.

3. A method according to claim 1, characterized in that request to join comprises a unicast type address specifying said source router (RS) and a multicast type group address.

4. A method according to claim 1, characterized in that in the presence of a unicast type routing protocol, each router (R) of said network measures the intensities of signals coming from each of its neighboring routers, and then each measured intensity is compared with a selected threshold so that in the event of a router detecting a measured intensity below said threshold on a link with a neighboring router, said router sends said message to each of its neighboring routers, and in that said message comprises information representative of said link being interrupted.

5. A method according to claim 4, characterized in that said information designates the router that can no longer be reached because of the link interruption.

6. A method according to claim 1, characterized in that in each router, the time that has elapsed since the beginning of detecting intensity below the threshold is counted, so that said message is not transmitted until a selected timeout duration has elapsed.

7. Apparatus (D) for predicting the interruption of a link between routers, for use in a router (RR, R) of an ad hoc communications network using a MANET type routing protocol, the apparatus being characterized in that it comprises processor means (MT) arranged to act in the router in which it is equipped to compare a measured intensity of signals coming from at least one of the neighboring routers with a selected threshold so that in the event of detecting a measured intensity below said threshold on a link with a neighboring router, it considers that said link is interrupted and orders a message to be sent to at least one of said neighboring routers in order to mitigate the consequences of said link being interrupted; and in that in the presence of a multicast type routing protocol and a hierarchical tree structure of the “parent/child” type, set up between a “source” router (RS) and at least one “receiver” router (RR) of said network, and in which the router (R2_{A}) having said apparatus fitted thereto forms a part, said processor means (MT) are arranged to compare said selected threshold with the measured intensities of signals coming from a router (R3_{A}) of said tree structure that constitutes a “parent” router for said router (R2_{A}), so that in the event of detecting a measured intensity less than said threshold over a link with said parent router (R3_{A}), it orders said message to be transmitted in point-to-point mode to a neighboring router (R4_{A}) of said network other than said parent router (R3_{A}), and in that said message comprises a request to join said tree structure, and specifies said source router (RS).

8. Apparatus according to claim 7, characterized in that said processor means (MT) are arranged to deliver requests to join, each comprising a unicast type address designating said source router (RS) and a multicast type group address.

9. Apparatus according to claim 7, characterized in that in the presence of a unicast type routing protocol, said processor means (MT) are arranged to compare said selected threshold with the measured intensities of signals coming from each of the routers neighboring the router (Ri) in which said apparatus is fitted, so that in the event of detecting a measured intensity below said threshold over a link with a neighboring router, the apparatus orders said message to be transmitted to each of said neighboring routers, said message then comprising information representative of said link being interrupted.

10. Apparatus according to claim 9, characterized in that said processor means (MT) are arranged to generate information specifying the router which can no longer be reached because of the link interruption.

11. Apparatus according to claim 7, characterized in that it includes counter means (T) coupled to said processor means (MT) and arranged, in the event of measured intensity being detected below said threshold, to trigger counting a timeout and to deliver a timeout signal when the time that has elapsed since the beginning of said detection is equal to a selected timeout duration, and in that said processor means (MT) are arranged to transmit said message on receiving said timeout signal.
